(19) United States
(12) Patent Application Publication
(10) Pub. No.: US 2017/0259690 A1
(43) Pub. Date: Sep. 14, 2017

(54) CHARGING/DISCHARGING CONTROL DEVICE FOR ONBOARD SECONDARY CELL

(71) Applicant: TOYOTA JIDOSHA KABUSHIKI KAISHA, Toyota-shi, Aichi-ken (JP)

(72) Inventors: Tatsuya KOGA, Toyota-shi (JP); Ryo MANO, Nisshin-shi (JP); Teruo ISHISHITA, Miyoshi-shi (JP); Toshihiro IWATA, Toyota-shi (JP)

(73) Assignee: TOYOTA JIDOSHA KABUSHIKI KAISHA, Toyota-shi, Aichi-ken (JP)

(21) Appl. No.: 15/529,605

(22) PCT Filed: Oct. 13, 2015
(86) PCT No.: PCT/JP2015/078910

§ 371 Date: May 25, 2017

(30) Foreign Application Priority Data
Nov. 28, 2014 (JP) 2014-242421
Aug. 10, 2015 (JP) 2015-158028

(51) Int. Cl. B60L 11/18; H02J 7/00; H01M 10/46; B60K 6/28; H01M 10/48

(52) U.S. Cl. CPC B60L 11/1862; B60L 11/1814; B60K 6/28; H01M 10/488; H01M 10/46; H02J 7/0047; H02J 7/0068; Y10S 903/907; B60Y 2200/92; B60Y 2300/91; B60L 2240/547; B60L 2240/80; H01M 2220/20

(57) ABSTRACT

In the present invention, in a vehicle equipped with an engine, a dynamo-electric machine, and a secondary cell as a power storage device, when supplying of electric power from the engine to the power storage device is stopped, an indicator value indicating the degree to which the ion concentration in an electrolytic solution is biased by discharging of the power storage device is acquired, a shift position is acquired from a shift lever mechanism of the vehicle, the acquired shift position is the neutral position, and the acquired indicator value exceeds a threshold value at which cell degradation occurs, the charging/discharging control device for an onboard secondary cell according to the present invention causes a notification means to issue a notification as a warning to change from the neutral position to another shift position.

### TECHNICAL FIELD

The present disclosure relates to a charging/discharging control device for onboard secondary cell, and more particularly to a charging/discharging control device for onboard secondary cell when the secondary cell has a property in which the ion concentration in electrolytic solution is biased due to discharging is equipped in a hybrid vehicle.

### BACKGROUND

There are hybrid vehicles having specifications in which an engine and a dynamo-electric machine are in a non-drive state when a shift lever is operated to a neutral position by a user (for example, patent document 1). In this hybrid vehicle, when the shift lever is at a neutral position, power for charging a battery is not generated. On the other hand, there are devices other than the dynamo-electric machine, which requires power supply even in the neutral position, such as illuminating lamps at night. From their discharging, the state of charge (SOC), which is the remaining battery capacity, continues to decrease in the neutral position.

Thereupon, patent document 1 discloses a control device for hybrid vehicles for outputting a warning to prompt the selection of a shift position other than the neutral position when the SOC, which is the remaining battery capacity, decreases to a predetermined threshold value.

Patent document 2 points out the battery degrades when the discharging of a large current continues in a hybrid vehicle using lithium ion cells for the battery. Here, calculating an evaluation value relating to degradation of the battery due to discharging to correspond to a change in bias of an ion concentration, and when the evaluation value changes to the degradation side from a target value, making small a discharge output upper limit value (W_{OUT}) are described.

Patent document 3 describes the battery also degrades due to continuous discharging in hybrid vehicles and describes as monitoring methods the monitoring of a degree of increase of cell resistance or the monitoring of a degradation evaluation value D indicating bias between electrodes of a lithium ion concentration in electrolytic solution in a lithium ion cell. Here, starting a restriction of the discharge output upper limit (W_{OUT}) of the battery when the degradation evaluation value D is exceeded is described.

The degradation evaluation value D is obtained from{D(current cycle time)=D (previous cycle time)−D(−)+D(+)}. The amount of decrease D (−) of the degradation evaluation value becomes a large value as a forgetting factor A increase and a cycle time lengthens, and the amount of increase D (+) of the degradation evaluation value becomes a large value as the battery discharging current value increases and the cycle time lengthens. The forgetting factor A is a coefficient corresponding to diffusion velocity of lithium ions in electrolytic solution of the battery and becomes a large value as battery temperature rises.

### CITATION LIST

### Patent Literature

Patent document 1: JP 2008-094178 A
Patent document 2: JP 4494453 B
Patent document 3: JP 2012-218599 A

### SUMMARY

### Technical Problem

Secondary cells, such as lithium ion cells, having a property in which the ion concentration in electrolytic solution is biased due to discharging, are known to degrade due to the temporary discharging of large current and also to degrade from continuous discharging even if the discharging is not of a large current. When discharge degradation progresses, the charging performance, for example, of these types of secondary cells decreases. Patent document 1 in which the SOC is monitored is insufficient with respect to the occurrence of discharge degradation of these types of secondary cells. In patent documents 2, 3, although discharge degradation of the lithium cell can be monitored and the operation of the inverter circuit for driving the dynamo-electric machine stops at the discharge restriction due to W_{OUT}, the discharging, such as to the lights and lamps, does not stop so that discharging still continues and discharge degradation progresses. For example, when a shift lever is shifted to a neutral position by a user in a hybrid vehicle having specifications for setting an engine and a dynamo-electric machine to a non-drive state and the shift position is at neutral, even though the engine stops and charging from the engine to the secondary cell is not performed, discharging, such as to the lights and lamps, continues so that discharge degradation of the secondary cell progresses.

The purpose of the present disclosure is to provide a charging/discharging control device for onboard secondary cell capable of suppressing the occurrence of discharge degradation for a secondary cell having the property in which the ion concentration in electrolytic solution is biased due to discharging.

### Solution to Problem

The charging/discharging control device for onboard secondary cell relating to the present disclosure has a notification means for notifying the user of a predetermined warning when, in a vehicle equipped with an engine, a dynamo-electric machine, and a secondary cell, power supply from the engine side to the secondary cell has been stopped and when an indicator value indicating the degree to which the ion concentration in an electrolytic solution is biased by discharging of the secondary cell exceeds a predetermined cell degradation threshold value.

In the charging/discharging control device for onboard secondary cell relating to the present disclosure, it is preferable to acquire the indicator value and acquire the vehicle shift position, and when the acquired shift position is at the neutral position, to stop the power supply from the engine side to the secondary cell , and when the acquired indicator value exceeds a cell degradation threshold value, to perform notification as a predetermined warning so that the neutral position is changed to another shift position.

In the charging/discharging control device for onboard secondary cell relating to the present disclosure, it is preferable to perform a process to stop the discharging of the secondary cell after notification was performed when the acquired indicator value increases toward degradation of the secondary cell and the amount of increase exceeds a predetermined threshold amount of increase.

In the charging/discharging control device for onboard secondary cell relating to the present disclosure, when the shift position after notification is acquired and in a predetermined period from the point at which notification was performed the acquired shift position is changed from the neutral position to another shift position, then again returned to the neutral position, it is preferable to perform notification so that the neutral position is changed to another shift position with a stronger notification manner than the previously notified predetermined warning.

In the charging/discharging control device for onboard secondary cell relating to the present disclosure, the shift position is acquired after discharge stop was performed, and in a predetermined period from the point at which discharge stop was performed a discharge stop cancellation request is performed by user operation, and when the acquired shift position remains in the state of the neutral position, it is preferable to perform a process for adding a predetermined standby time with respect to the user discharge stop cancellation request.

In the charging/discharging control device for onboard secondary cell relating to the present disclosure, it is preferable for the indicator value to be any one of a degradation evaluation value indicating ion concentration bias in electrolytic solution between electrodes of the secondary cell, an increase rate of cell resistance in the discharging period of the secondary cell, and a time integration value of discharging current of the secondary cell.

### Advantageous Effects of Invention

According to the charging/discharging control device for onboard secondary cell of the aforementioned configuration, when the power supply from the engine side to the secondary cell has been stopped and the indicator value indicating the degree to which the ion concentration in electrolytic solution is biased due to discharging of the secondary cell, the user is notified of the predetermined warning. As a result, the occurrence of discharge degradation of the onboard secondary cell having the property in which the ion concentration in electrolytic solution is biased due to discharging can be prevented.

Depending on the hybrid vehicle, the vehicle may have specifications for setting the engine and dynamo-electric machine to a non-drive state when the shift lever is shifted to the neutral position by the user. Thereupon, in the charging/discharging control device for onboard secondary cell, when the shift position is at the neutral position and the indicator value exceeds the cell degradation threshold value, notification is performed so that the neutral position is changed to another shift position. When left at the neutral position even in a state in which the power supply from the engine to the power storage device is stopped and charging is not performed, discharging of the power storage device may continue, such as through the hybrid vehicle's lights, lamps, air-conditioner, engine ignition device, and power steering. This discharging in the neutral position continues regardless of the W_{OUT} restriction relating to the operation of the inverter circuit. According to the aforementioned configuration, when the indicator value exceeds the cell degradation threshold value, the user is notified so that the neutral position is changed to another shift position so that the occurrence of discharge degradation of the onboard secondary cell can be prevented.

Furthermore, in the charging/discharging control device for onboard secondary cell, when the indicator value increases toward degradation of the secondary cell after notification was performed and exceeds the predetermined threshold increment, a process to stop the discharging of the secondary cell is executed. As a result, the occurrence of discharge degradation of the onboard secondary cell can be suppressed, such as in the case in which the neutral position is left unchanged even though warning notification was performed.

Furthermore, in the charging/discharging control device for onboard secondary cell, when warning notification was performed for secondary cell degradation prevention, depending on the user, the neutral position may be temporarily changed to another shift position because notification was performed, then thereafter a short time returned again to the neutral position. In such a case, sufficient charging current to the power storage device, which is the secondary cell, is not supplied and the indicator value may exceed the cell degradation threshold value. In such an instance, if degradation originating in discharging is not effectively prevented, notification is performed so that the neutral position is changed to another shift position with a stronger notification manner than the previous warning. For example, when notification is by sound, notification is performed at a larger volume than previously, when notification is by warning lamp illumination, illumination is performed with a stronger light than previously, or blinking is repeated when continuous illumination was used previously, and when notification is by warning display, the display of large characters is used. As a result, the occurrence of discharge degradation of the onboard secondary cell can be effectively suppressed, such as after temporarily changing from the neutral position to another shift position because of the warning notification, in the case, for example, of alternately changing between the neutral position and another shift position.

Furthermore, in the charging/discharging control device for onboard secondary cell, when the discharge stop process is performed for secondary cell degradation prevention, depending on the user, within a short time after becoming aware the discharge stop process was performed, the discharge stop cancellation request may be performed by operation of an operator provided in the vehicle with the shift position left at the neutral position. In such a case, when the discharge stop is cancelled in response to user request, sufficient charging current to the power storage device, which is the secondary cell, is not supplied and degradation originating discharging is not effectively prevented. In such an instance, a predetermined standby time is added with respect to the user discharge stop cancellation request. As a result, performing the discharge stop cancellation by user operation, such as immediately after the discharge stop process was performed, can be prevented so that the occurrence of discharge degradation of the onboard secondary cell can be effectively suppressed.

Furthermore, in the charging/discharging control device for onboard secondary cell, the indicator value is any one of the degradation evaluation value indicating ion concentration bias of electrolytic solution between electrodes of the secondary cell, the increase rate of cell resistance in a discharging period of the secondary cell, and the time integration value of discharging current value of the secondary cell.

### BRIEF DESCRIPTION OF DRAWINGS

FIG. 1 shows a control system of a hybrid vehicle including an embodiment of the charging/discharging control device for onboard secondary cell of the embodiment relating to the present disclosure;

FIG. 2 shows biasing of ion concentration in electrolytic solution during discharging in a lithium ion cell as an example of a secondary cell having a property in which the ion concentration in the electrolytic solution is biased due to discharging with FIG. 2(a) showing a state of the lithium ion cell during discharging and FIG. 2(b) showing biasing of the ion concentration in the electrolytic solution;

FIG. 3 shows power storage device temperature T_{B} dependency in the forgetting factor A used in the degradation evaluation value D, which is an example of the indicator value E used in the charging/discharging control device for onboard secondary cell of the embodiment relating to the present disclosure;

FIG. 4 is a flowchart showing charging/discharging control procedure in the charging/discharging control device for onboard secondary cell of the embodiment relating to the present disclosure;

FIG. 5 is a detailed diagram of the procedure in the state of no history at the history state branching of FIG. 4;

FIG. 6 is a logical value table for condition K used in FIG. 4;

FIG. 7 is a detailed diagram of the procedure when in the state of warning notification history exists at the history state branching of FIG. 4;

FIG. 8 is a detailed diagram of the procedure when in the state of warning notification cancellation history exists at the history state branching of FIG. 4; and

FIG. 9 is a detailed diagram of the procedure when in the state of discharge stop history exists at the history state branching of FIG. 4.

### DESCRIPTION OF EMBODIMENTS

An embodiment of the present disclosure will be described in detail hereinafter using the attached drawings. Hereinafter, a hybrid vehicle is described with specifications in which the operation of an engine is stopped and charging current is not supplied to a power storage device when the shift position is at a neutral position. However, this is an example of charging current not supplied to the power storage device and a hybrid vehicle may have other specifications. For example, a hybrid vehicle in which a clutch is provided between an engine and a dynamo-electric machine, which performs electric generation, may have specifications in which disengaging the clutch stops electric power supply to the power storage device while the engine continues to operate.

Although a lithium ion cell is described hereinafter as the onboard secondary cell, this is an example for the purpose of illustration. Since most secondary cells use electrolytic solutions, any secondary cell among them having the property of ion concentration in electrolytic solution being biased due to discharging is applicable. Although two dynamo-electric machines are provided hereinafter for the hybrid vehicle equipped with the secondary cell, this is an example for the purpose of illustration and there may be any number of dynamo-electric machines. Furthermore, identical parts in all drawings hereinafter are designated like reference characters and their descriptions will not be duplicated.

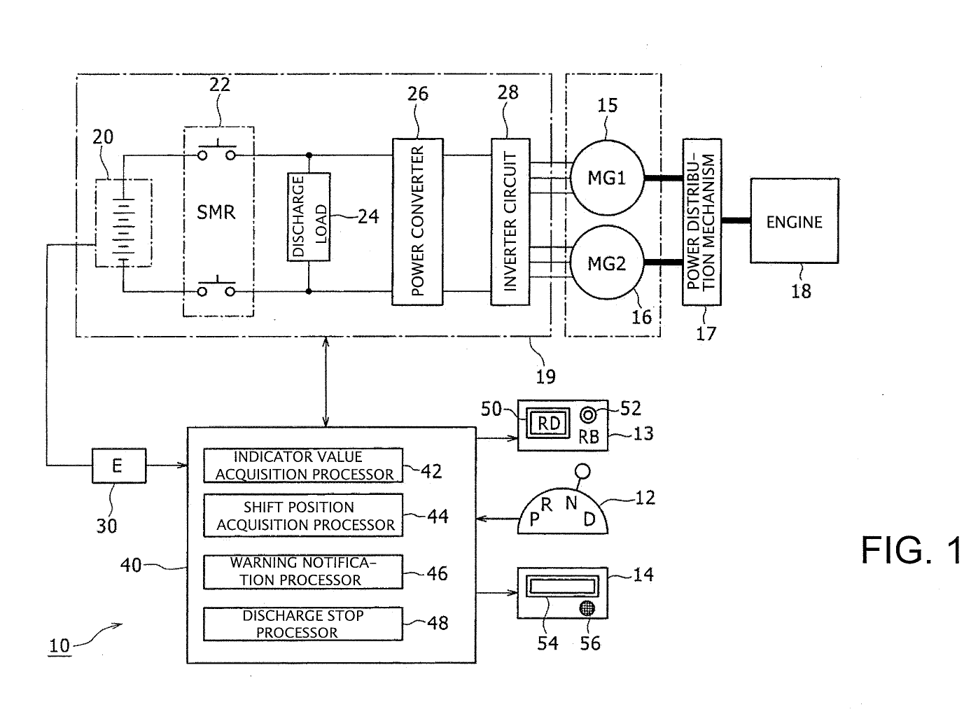

FIG. 1 is a block diagram showing the configuration of a hybrid vehicle control system 10 including a charging/discharging control device for an onboard secondary cell. The hybrid vehicle control system 10 comprises a shift lever mechanism 12, a display means 13 relating to a dischargeable state of a power storage device 20, a notification means 14 for notifying a user of a warning relating to discharge degradation of the power storage device 20, two dynamo-electric machines 15, 16, an engine 18, a power distribution mechanism 17 provided between the engine 18 and the two dynamo-electric machines 15, 16, a drive circuit 19 connected to the dynamo-electric machines 15, 16, and an onboard secondary cell charging/discharging control device 40 for controlling charging/discharging operation of the drive circuit 19. Unless otherwise specified, the onboard secondary cell charging/discharging control device 40 will be referred to hereinafter as the charging/discharging control device 40.

The shift lever mechanism 12 is one driver device in the hybrid vehicle and is an operation lever mechanism operated, for example, to change a shift position corresponding to a gear combination of a manual transmission. In the example of FIG. 1, a drive position (D), a reverse position (R), a parking position (P), and a neutral position (N) are shown as shift positions and the current shift position is the neutral position (N). The state of the shift position in the shift lever mechanism 12 is transferred to the charging/discharging control device 40 via appropriate signal wiring. This hybrid vehicle has specifications in which the operation of the engine 18 is stopped when the shift position is at the neutral position, and the engine starts when the shift position is changed from the neutral position to another shift position such as the parking position.

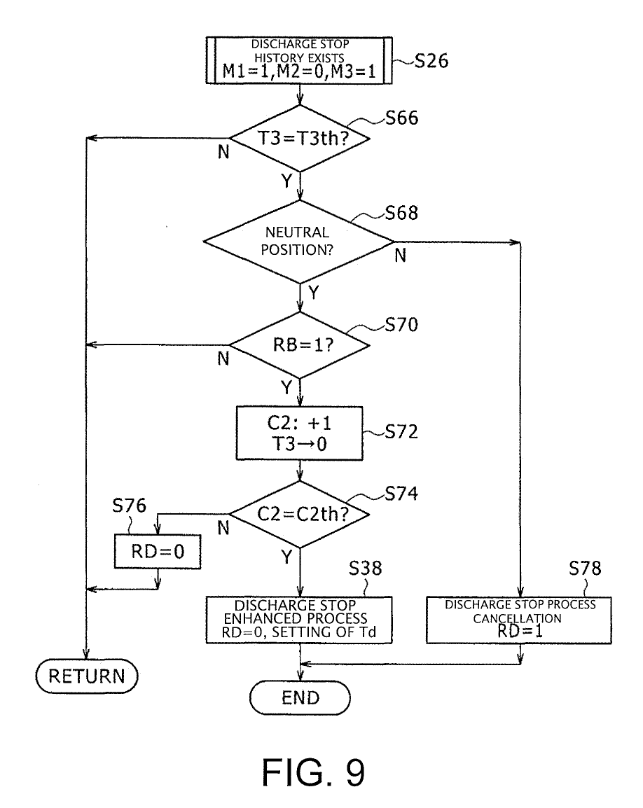

The display means 13 is connected to the charging/discharging control device 40 via appropriate signal wiring and displays to the user whether the power storage device 20 is in a dischargeable state or a discharge stop state. A display section 50 in the display means 13 has a character display of “RD”. The character display of “RD” illuminates when the power storage device 20 is in a dischargeable state and the character display of “RD” turns off when in a discharge stop state. “RD” means Ready for Discharge. An operator 52 in the display means 13 is a user operator so that a user can perform a discharge stop cancellation request when the power storage device 20 is in the discharge stop state. When the operator 52 is operated by a user, an “RB” signal is transferred to the charging/discharging control device 40. Details on the operator 52 are described in FIG. 9.

The notification means 14 is connected to the charging/discharging control device 40 via appropriate signal wiring and notifies the user of a warning in accordance with a command transferred from the charging/discharging control device 40. The notification is a warning relating to discharge degradation of the power storage device 40 due to discharging. A display 54 in the notification means 14 is a display device for displaying warning messages. A buzzer 56 in the notification means 14 is a sound emitting device for outputting warning sounds. These components are an example of the notification means 14 and other components can be used in accordance with a warning, such as a lit or flashing warning lamp, or a speaker for outputting audio warning messages. The discharge degradation of the power storage device 20 and specific warning notifications will be described hereinafter.

The two dynamo-electric machines 15, 16 are motor generators (MG) forming the driving source for the hybrid vehicle. The motor generators are three-phase synchronous dynamo-electric machines functioning as motors when electric power is supplied from the drive circuit 19 and functioning as generators during braking of the hybrid vehicle. The two dynamo-electric machines 15, 16 are distinguished and referred to as MG1, MG2. The dynamo-electric machine 15 shown as MG1 is connected to the engine 18 side of the power distribution mechanism 17 and functions mainly as a generator driven by the engine 18 via the power distribution mechanism 17. The dynamo-electric machine 16 shown as MG2 is connected to the drive shaft side of the hybrid vehicle in the power distribution mechanism 17 and functions mainly to drive the drive wheels.

The engine 18 is an internal combustion engine, which is one driving source for the hybrid vehicle. The engine 18 is, for example, a six-cylinder, piston-cylinder mechanism. The power distribution mechanism 17 provided between the engine 18 and the two dynamo-electric machines 15, 16 has a function for appropriately distributing in accordance with the traveling state of the hybrid vehicle a portion used for power generation and a portion driving the drive wheels among an output of the engine 18, an input/output to the dynamo-electric machine 15, which is MG1, and an output of the dynamo-electric machine 16, which is MG2. A planetary gear mechanism can be used for the power distribution mechanism 17.

The drive circuit 19 includes the power storage device 20, a system main relay 22 shown as SMR, a discharge load 24 operated using electric power from the power storage device 20, a power converter 26, and an inverter circuit 28.

The power storage device 20 is a secondary cell comprised using an electrolytic solution. The power storage device 20 supplies DC power to the discharge load 24 and supplies power to the dynamo-electric machines 15, 16 via the power converter 26 and the inverter circuit 28. Furthermore, the power storage device 20 is charged by receiving charging power from the dynamo-electric machines 15, 16 via the inverter circuit 28 and the power converter 26. A lithium ion battery, which is a battery pack of lithium ion cells, is used for the power storage device 20. Many types of secondary cells can be used instead of lithium ion cells, however, the case is described using for the power storage device 20 a secondary cell having the property in which the ion concentration of electrolytic solution is biased due to discharging.

The system main relay 22 is a relay device for disconnecting or connecting an electrical connection between the power storage device 20 and elements other than the power storage device 20 comprising the drive circuit 19. When the system main relay 22 develops contact sticking, for example, difficulty in disconnection or connection occurs so that after a power switch of the hybrid vehicle turns on and an electronic control unit (ECU) becomes operational, a safety check such as for contact sticking, is performed, and thereafter a connected state is set. When the system main relay 22 enters the connected state, the power storage device 20 enters a dischargeable state and a character display of “RD” illuminates on the display section 50 of the display means 13. As will be described hereinafter, a discharge stop process can be executed to prevent discharge degradation of the power storage device 20. The discharge stop process for the power storage device 20 sets the system main relay 22 to the disconnected state under control of the charging/discharging control device 40. At this time, the character display of “RD” on the display section 50 of the display means 13 turns off. In this manner, the off state or the on state of the character display of “RD” informs the user of the disconnected or connected state of the system main relay 22.

Although not an element of the drive circuit 19, the discharge load 24 is a group of devices operated by DC power from the power storage device 20 via the system main relay 22. Examples are lights, lamps, air conditioner, engine ignition device, and power steering device of the hybrid vehicle. These devices are operational provided the system main relay 22 is not disconnected. In other words, even when the operation of the inverter circuit 28 stops and power from the power storage device 20 is not supplied to the dynamo-electric machines 15, 16, discharging from the power storage device 20 to the discharge load 24 is performed provided the system main relay 22 is in the connected state.

The power converter 26 is provided and connected between the power storage device 20 and the inverter circuit 28, and when there is a voltage difference between the DC voltage value of the power storage device 20 and a system voltage value, which is the voltage between the positive electrode side and the negative electrode side of the inverter circuit 28, the DC voltage value of the power storage device 20 side is raised to the system voltage value of the inverter circuit 28, and, conversely, the system voltage value of the inverter circuit 28 is lowered to the DC voltage value of the power storage device 20 side. The power converter 26 is comprised to include an inductor, a switching element, and so forth.

The inverter circuit 28 is a circuit performing AC/DC conversion between the DC power of the power storage device 20 and the three-phase AC power of the dynamo-electric machines 15, 16. The AC/DC conversion includes converting the DC power of the power storage device 20 to the three-phase AC power for the dynamo-electric machines 15, 16 or converting the three-phase AC power from the dynamo-electric machines 15, 16 to the DC power for the power storage device 20. The inverter circuit 28 is comprised to include a plurality of switching elements and a plurality of diodes.

When the SOC of the power storage device 20 drops and reaches a lower limit, the power storage device 20 cannot be further discharged so the inverter circuit 28 stops the operation thereof based on control of the charging/discharging control device 40. As a result, the operation of the dynamo-electric machines 15, 16 stops. At this time also, provided discharge degradation does not occur at the power storage device 20, the power storage device 20 is not set to the discharge stop state and the system main relay 22 is connected so that the character display of “RD” on the display section 50 in the display means 14 continues to illuminate.

An indicator value calculator 30 connected to the power storage device 20 calculates an indicator value E indicating the degree to which the ion concentration of the electrolytic solution is biased due to discharging of the secondary cell. The calculated indicator value E is transferred to the charging/discharging control device 40 via appropriate signal wiring. Details of the indicator value E will described hereinafter.

The charging/discharging control device 40 controls the overall operation of the drive circuit 19 comprising the power storage device 20, the system main relay 22, the power converter 26, and the inverter circuit 28. The charging/discharging control device 40 can utilize a computer suited for vehicle mounting.

The charging/discharging control device 40 is provided with an indicator value acquisition processor 42 for acquiring the indicator value E transferred from the indicator value calculator 30, and a shift position acquisition processor 44 for acquiring the shift position state from the shift lever mechanism 12. Thus, the indicator value necessary for charging/discharging control processing is acquired and the shift position state is acquired. Furthermore, to prevent discharge degradation of the power storage device 20, the charging/discharging control device 40 is comprised to include a warning notification processor 46 for performing a process to notify the user of a predetermined warning via the notification means 14, for example, so that the user changes the neutral position to another shift position when the shift position is at the neutral position, and a discharge stop processor 48 for performing a process to stop the discharging of the power storage device 20, such as when the user leaves the neutral position as is despite being notified of the warning.

Such functions are implemented by executing software loaded in the charging/discharging control device 40. More specifically, the charging/discharging control device 40 can be implemented by executing a charging/discharging control program as software. Part of such functions may be implemented in hardware.

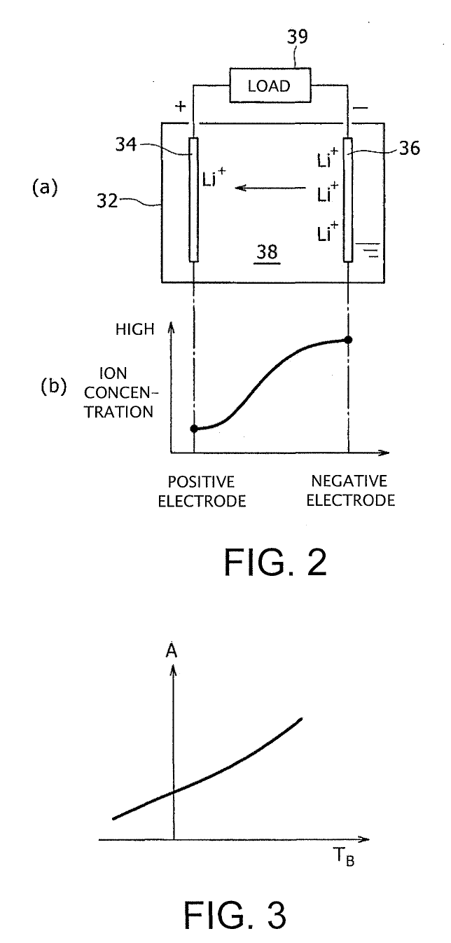

Here, biasing of the ion concentration in the electrolytic solution due to discharging of the power storage device 20 will be described using FIG. 2. FIG. 2(a) shows the state of a lithium ion cell during discharging and (b) shows biasing of the ion concentration in the electrolytic solution.

FIG. 2 illustrates a lithium ion cell 32 comprising the lithium ion battery. The lithium ion cell 32 is comprised to include a positive electrode 34, a negative electrode 36, and an electrolytic solution 38 covering the positive electrode 34 and the negative electrode 36 and filling therebetween. The positive electrode 34 and the negative electrode 36 are comprised of materials capable of reversible occlusion and release of lithium ions (Li+).

For the positive electrode 34, lithium transition metal oxide, such as lithium cobalt oxide, is used, and for the negative electrode 36, carbon is used. The electrolytic solution 38 uses an ion electrolytic solution including a lithium salt, such as lithium hexafluorophosphate (LiPF₆), in an organic solvent, such as ethylene carbonate or diethyl carbonate. Hereinafter, lithium hexafluorophosphate (LiPF₆) is used for the lithium salt.

When discharging continues in the lithium ion cell 32, biasing of the lithium ion concentration inside the cell occurs. This is shown in FIG. 2(b).

When such biasing of the lithium ion concentration occurs, cell resistance increases.

In the power storage device 20, which is the lithium ion battery, when the time integration value of the discharging current value (time integration value of Ah with discharging current value A and discharging time h) increases, the ion concentration of the electrolytic solution 38 is biased and the cell resistance during the discharging period of the power storage device 20 rises. Therefore, for the indicator value E indicating the degree of ion concentration bias in the electrolytic solution 38 between the positive electrode 34 and the negative electrode 36 of the power storage device 20, the time integration value of the discharging current value of the power storage device 20, the increase rate of the cell resistance during the discharging period of the power storage device 20, and a degradation evaluation value indicating ion concentration bias of the electrolytic solution 38 between the positive electrode 34 and the negative electrode 36 of the power storage device 20 can be used. For the degradation evaluation value, the degradation evaluation value D mentioned in patent document 3 can be used. Hereinafter, the degradation evaluation value D is used for the indicator value E.

As mentioned in patent document 3, the degradation evaluation value D is calculated by D(current cycle time)={D(previous cycle time)−D(−)+D(+)} from the degradation evaluation value D of each cycle time in a predetermined cycle time and amount of increase D(+) and amount of decrease D(−) of the degradation evaluation value D in one cycle of the cycle time. D(0) in the first cycle time is, for example, set as 0.

The amount of increase D(+) of the degradation evaluation value D becomes a large value as the discharging current value of the power storage device 20 increases and the cycle time lengthens. The amount of decrease D(−) of the degradation evaluation value D becomes a large value as a forgetting factor A increases and the cycle time lengthens.

The forgetting factor A is a coefficient corresponding to the diffusion velocity of lithium ions (Li+) in the electrolytic solution 38 of the power storage device 20 and the forgetting factor A is set so that the product with the cycle time ΔT is from 0 to 1. FIG. 3 shows the power storage device temperature T_{B} dependency in the forgetting factor A. The forgetting factor A becomes a large value as the temperature T_{B} of the power storage device 20 increases. Therefore, since the forgetting factor A is obtained from the temperature T_{B} of the power storage device 20, D(+) is obtained from the cycle time ΔT and the discharging current value of the power storage device 20, D(−) is obtained from the cycle time ΔT and the forgetting factor A, and degradation evaluation value D(N) is obtained from the formula of D(current cycle time)={D(previous cycle time)−D(−)+D(+)} with D(0)=0, this can be used as the indicator value E.

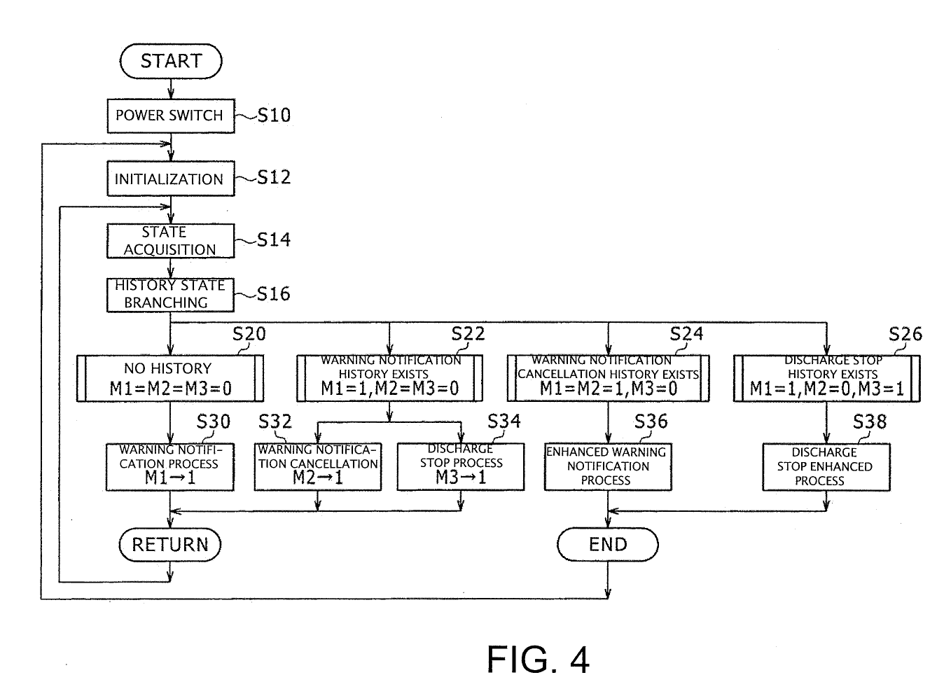

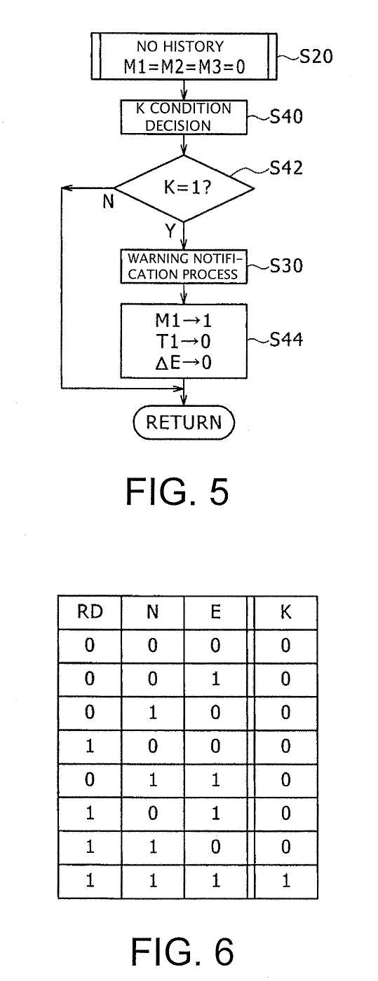

The above-mentioned configuration and particularly the various functions of the charging/discharging control device 40 are described in detail using FIG. 4 through FIG. 9. These drawings relate to the charging/discharging control procedure in the charging/discharging control device 40. FIG. 4 is a flowchart showing the overall procedure processed in one control cycle and FIG. 5 and FIG. 7 through FIG. 9 are flowcharts showing details of parts of the procedure of FIG. 4. The various procedures correspond to the various processes of the charging/discharging control program. FIG. 6 is a logical value table for condition K to be described hereinafter.

In a hybrid vehicle, when a power switch is turned on (S10), power is supplied to various ECUs from a low voltage supply, such as lead power storage device, the operation of the various ECUs begins, and safety confirmation of the system main relay 22, for example, is executed. The turning on of the power switch can be performed, for example, by the user turning on a switch device, such as an ignition switch, or by the user turning on a switch device via remote non-contact operation using a remote switch device. When the power switch is turned on, the various components of the control system 10 of the hybrid vehicle are set to an initial state and the charging/discharging control program in the charging/discharging control device 40 starts up.

The procedure of the charging/discharging control program branches to four history states after program initialization (S12), state acquisition (S14), and history state branching (S16). The four history states are “no history” (S20), “warning notification history exists” (S22), “warning notification cancellation history exists” (S24), and “discharge stop history exists” (S26). When the processes in “no history” (S20) and “warning notification history exists” (S22) are executed in sequence within one control cycle, “RETURN” returns the execution to S14. After returning to S14, state acquisition occurring during processing in the previous control cycle is performed and in accordance with the four history state branches based thereon, the process for the next control cycle is executed. When the processes of “warning notification cancellation history exists” (S24) and “discharge stop history exists” (S26) complete in the control cycle, the process of the general charging/discharging control program completes and is considered to be the “END”. While the power switch in the hybrid vehicle is on, since it is necessary to continuously prevent discharge degradation of the power storage device 20, the execution returns to S12 at “END”, and the program initializes, then starts a new discharge control process.

The initialization process (S12) of the charging/discharging control program sets all the state variables to be acquired in the next S14 to the initialized state. The process for state acquisition (S14) is for acquiring states in the control cycle for the state variables used in the procedure from S16. State variables used in the procedure from S16 are the logical values RD, N, and E shown in the logical value table of FIG. 6 for condition K, the logical values M1, M2, and M3, which are history states distinguishing the four history states (S20, S22, S24, S26), the elapsed times of various counters, the count values of the various counters, and so forth. These will be sequentially described in detail hereinafter.

The process for history state branching (S16) is a branch setting process for branching the process in the current control cycle in accordance with the process history of the previous control cycle. History state branching branches into four history states. Here, history is shown as the three history states of M1 showing process completion of the warning notification process (S30) executed in the branch processing of “no history” (S20), M2 showing process completion of warning notification cancellation (S32) executed in the branch process of “warning notification history exists” (S22), and M3 showing process completion of the discharge stop process (S34).

In the history state branching procedure, the subsequent procedure is branched in accordance with the four history states. First, the history state is “no history” (S20). Here, the state is M1=M2=M3=0. At this time, the warning notification process (S30) is executed. When the warning notification process (S30) completes, a setting change to M1=1 is performed. Second, the history state is “warning notification history exists” (S22). Here, the state is M1=1, M2=M3=0. At this time, the warning notification cancellation (S32) or the discharge stop process (S34) is executed. When the warning notification cancellation (S32) completes, a setting change to M2=1 is performed, and when the discharge stop process (S34) completes, a setting change to M3=1 is performed.

When the shift position in the hybrid vehicle is at the neutral position, charging current is not supplied to the power storage device 20 and the system main relay 22 is in the connected state in which “RD” is illuminated, discharging occurs from the power storage device 20 to the discharge load 24, such as lights. As a result, the indicator value E indicating the degree to which the ion concentration in the electrolytic solution 38 of the power storage device 20 is biased is on the degradation side. At such a time, the warning notification process (S30) in the first branch issues a warning to prompt for the shifting of the shift position to a position other than neutral. When the shift position is left at the neutral position despite the warning, the discharge stop process (S34) in the second branch forcibly disconnects the system main relay 22 to set the discharge stop state turning off “RD”. An enhanced warning notification process (S36) in the “warning notification cancellation history exists” (S24) of the third branch and a discharge stop enhanced process (S38) in the “discharge stop history exists” (S26) of the fourth branch enhance the effect of the warning notification process (S30) and the discharge stop process (S34).

FIG. 5 is a flowchart showing the detailed procedure in the branch with the history state of “no history” (S20). Here, on the basis of the state variables acquired by the state acquisition process (S14), a K condition decision process (S40) is performed. The K condition decision process decides whether the logical value of the state variable K is K=1 or K=0 on the basis of the combination of logical values of the three state variables RD, N, and E. FIG. 6 is the logical value table used in the K condition decision process.

The state variable RD shows whether the power storage device 20 is in a dischargeable state or discharge stop state. RD=1 is the dischargeable state when the system main relay 22 is in the connected state and continues for a duration T₀ or longer. At this time, the character display of “RD” is illuminated on the display section 50 of the display means 13. RD=0 is the discharge stop state when the system main relay 22 is in the disconnected state. At this time, the character display of “RD” is off on the display section 50 of the display means 13. Therefore, the charging/discharging control device 40 obtains the connected or disconnected state of the system main relay 22 so that the power storage device 20 can be distinguished to be in the dischargeable state or discharge stop state. Or, by acquiring the illuminated state or the off state of the character display of “RD” on the display section 50 of the display means 13, the power storage device 20 can be distinguished to be in the dischargeable state or the discharge stop state.

The state variable N in a broad sense indicates the charging current to the power storage device 20 is in the supply stop state or the supply state. Here, since a hybrid vehicle is considered in which the engine stops when the shift position is at the neutral position, the state of the shift position is shown representing the state variable N. Hereinafter, unless otherwise specified, the neutral position is referred to simply as the N position. N=1 is a state in which the shift position is continuously at the N position for duration T₀ or longer and the supply of charging current to the power storage device 20 is stopped. N=0 is a state of shift position other than the N position, and is the state of P, R, or D in FIG. 1. In this state, charging current is supplied to the power storage device 20.

The state variable E shows the state of the indicator value E indicating the degree of ion concentration bias in the electrolytic solution 38 of the power storage device 20. E=1 is a state in which the indicator value E continuously exceeds a predetermined cell degradation threshold value E₀ for duration T₀ or longer and in which cell degradation of the power storage device 20 occurs. When this state continues, biasing of the ion concentration in the electrolytic solution 38 of the power storage device 20 increases, the internal resistance of the power storage device 20 rises, current concentration between electrodes further occurs, and the power storage device 20 may result in discharge degradation. Thus, the cell degradation threshold value E₀ sets with respect to the indicator value E a threshold value, which is a point (discharge degradation start point) where discharge degradation starts. The cell degradation threshold value E₀ can be predetermined empirically in accordance with specifications of the power storage device 20.

Even if the indicator value E temporarily exceeds the cell degradation threshold value E₀, the duration T₀ is set to avoid erroneous decision due to the indicator value E dropping when discharging cannot be performed thereafter, such as with the stopping of the operation of the discharge load 24.

For example, when the degradation evaluation value D is used for the indicator value E, D(−) in the degradation evaluation value D drops as the forgetting factor A increases and as the cycle time lengthens. As the temperature T_{B} of the power storage device 20 increases, the forgetting factor A is a large value. Thus, if the temperature T_{B} of the power storage device 20 is an appropriate temperature and not an extremely low temperature, and if D(−) is sufficiently large even with some D(+) due to discharging current, the degradation evaluation value D becomes smaller as time elapses. Similarly, regarding the increase rate of internal resistance of the power storage device 20, which is another example of the indicator value E, even if the indicator value E temporarily exceeds the cell degradation threshold value E₀, the increase rate of internal resistance drops when discharging cannot be performed thereafter, such as with the stopping of the operation of the discharge load 24. Therefore, the duration T₀ can be set as an appropriate period to avoid erroneous decision. As an example of the duration T₀, a degree of several times the control cycle Δt can be used. For example, T₀=3Δt can be used.

For state variable E=1, instead of the indicator value E exceeding the predetermined cell degradation threshold value E₀ for the duration T₀ or longer, a second threshold value E₁ may be set to a value larger than the cell degradation threshold value E₀ and a state in which the indicator value E exceeds the cell degradation threshold value E₀ and further exceeds the second threshold value E₁ may be set to E=1.

As shown in FIG. 6, the state variable K becomes K=1 when RD=N=E=1 and becomes K=0 otherwise. Namely, the state variable K becomes K=1 when all three state variables of RD, N, and E are “1” to satisfy the AND condition and becomes K=0 when any one becomes “0”.

When the state becomes K=1, the operation of the inverter circuit 28 stops and power generation of the dynamo-electric machines 15, 16 is not performed so that charging of the power storage device 20 is not performed, and further the system main relay 22 is in the connected state, the discharge load 24 is dischargeable, and the indicator value E of the power storage device 20 exceeds the predetermined cell degradation threshold value E₀ for the duration T₀ or longer.

Returning again to FIG. 5, the result of the K condition decision is determined to be K=1 or not (S42). If the decision of S42 is negative, the state is K=0 and there is no risk of the power storage device 20 degrading. In this case, the process in that control cycle completes at “RETURN” and returns to S14. If the decision of S42 is affirmative, K=1 and the possibility of discharge degradation of the power storage device 20 is high so that the user is notified with a predetermined warning (S30). This procedure is executed by function of the warning notification processor 46 of the charging/discharging control device 40. The predetermined warning prompts the user to take action to prevent discharge degradation of the power storage device 20. To prevent discharge degradation of the power storage device 20, it is necessary to set K=0 and as shown in FIG. 6 the condition of K=0 requires any one of RD=0, N=0, or E=0 to be satisfied. Of these, the state variable E is not user controllable. When the user sets RD=0, power from the power storage device 20 ceases to be supplied to the discharge load, such as a lamp. Therefore, the best course of action for the user to take to set K=0 is to set N=0. Thereupon, a content prompting the user to change the shift position from the N position to another shift position is used for the predetermined warning. The notification is performed by the notification means 14.

In the notification means 14, the buzzer 56 is turned on and a buzzer sound is output. Furthermore, a message display, such as “when buzzer sounds, change shift position from neutral to another position” is shown on the display 54. This is one example, and when the notification means 14 is provided with a warning lamp, the warning lamp is caused to blink or turn on, and when a display is also provided, a message, such as “when lamp turns on or blinks, change shift position from neutral to another position”, is displayed. When the notification means 14 is provided with an audio speaker, the aforementioned message is issued by audio. When the notification means 14 is provided only with a display, the aforementioned message is shown on the display. It should be noted that notification may be performed in combination thereof.

With the predetermined warning notification being performed, the state variable M1 changes from “0” to “1”. The state variable M1=1 indicates the history of predetermined warning notification that was performed. When the state variable becomes M1=1, the history state branching process of FIG. 4 moves to the branch for “warning notification history exists” (S22). The process in the branch for S22 utilizes an elapsed time T1 after the warning notification is performed so that with the state variable M1 being changed from “0” to “1”, the elapsed time is set to T1=0 and the timer T1 starts counting. Furthermore, the process in the branch for S22 utilizes an indicator value increment AE so that with the state variable M1 being changed from “0” to “1”, the indicator value increment is set to ΔE=0 and the count starts for the increment ΔE. When these setting operations (S44) end, the process in that control cycle completes and “RETURN” returns the execution to S14.

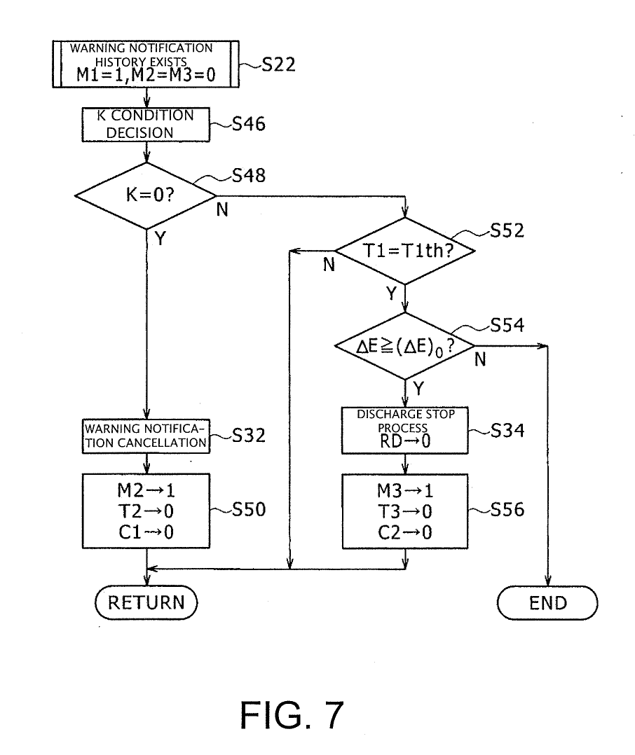

In the next control cycle, in S14, the states of all state variables are acquired and history state branching is again performed. The state acquisition process of S14 acquires M1=1 and proceeds to “warning notification history exists” (S22) in the history state branching of S16. FIG. 7 is a flowchart showing the detailed procedure in the branch for the history state of “warning notification history exists” (S22).

The branch for “warning notification history exists” (S22) includes a process for when the user takes action to prevent discharge degradation of the power storage device 20 and a process for when the user does not take action to prevent discharge degradation of the power storage device 20 even if warning notification is performed. The former is warning notification cancellation (S32) and the latter is discharge stop process (S34). The warning notification cancellation (S32) and the discharge stop process (S34) are closely related. Namely, when the user is aware of the warning notification and voluntarily shifts from the N position to another shift position, the purpose of the warning notification is achieved and the warning notification is cancelled (S32). In contrast, when the user does not take action to prevent discharge degradation of the power storage device 20 and leaves the shift position at the N position, the indicator value E increases so that the charging/discharging control device 40 forcibly sets RD=0. This is the discharge stop process (S34). Therefore, when the warning notification is cancelled the discharge stop process is not performed, and conversely, when cancellation of the warning notification is not performed within a predetermined time, the discharge stop process is performed. Namely, when either one of the warning notification cancellation (S32) or the discharge stop process (S34) is executed, the other one is not executed.

In the branch for “warning notification history exists” (S22), a condition K decision is performed (S46). This decision process is the same as S40 of FIG. 5 so a detailed description will be omitted. Regarding the decision for condition K, a decision is made as to whether or not K=0 (S48). When the decision of S48 is affirmative, K=0 indicates, for example, that the user has voluntarily shifted the shift position to the N position. Since the possibility of discharge degradation of the power storage device 20 becomes low as a result, notification of the predetermined warning is cancelled (S32). Cancellation of warning notification is performed by the notification means 14. In the notification means 14, the buzzer 56 is turned off and the buzzer sound stops. Furthermore, in the display 54, a message, such as “thank you”, is displayed. When the notification means 14 includes a warning lamp, the warning lamp is turned off and stops the illumination or blinking of the lamp. When the notification means 14 includes an audio speaker, the aforementioned message is issued by audio.

With the cancellation of the predetermined warning notification, the state variable M2 changes from “0” to “1”. The state variable M2=1 indicates the history of the predetermined warning notification being cancelled. When the state variable becomes M2=1, the history state branching process of FIG. 4 moves to the branch for “warning notification cancellation history exists” (S24). The process in the branch for S24 utilizes an elapsed time T2 after warning notification cancellation is performed so that with the state variable M2 being changed from “0” to “1”, the elapsed time is set to T2=0 and the timer T2 starts counting. Furthermore, the process in the branch for S24 utilizes a counter C1 for counting the number of times the user has performed the discharge stop cancellation request operation so that with the state variable M3 being changed from “0” to “1”, the count value of the counter C1 is reset to 0. When these setting operations (S50) end, the process in that control cycle completes and “RETURN” returns the execution to S14.

When the decision of S48 is negative, K=1 and is a state in which the user still has left the N position as is despite the warning notification. When this state continues a long time, the discharge degradation of the power storage device 20 cannot be prevented. Thereupon, it is determined (S52) whether or not time T1 has elapsed a predetermined time T1th from when warning notification was performed. When M1=1, T1=0 is set and T1th can be set while taking into consideration the time required for the user to voluntarily shift the shift position. As an example, T1th can be set to a few seconds. To easily decide the process timing, T1th is set to an integral multiple of the control cycle. When the decision of S52 is negative, T1 has still not reached T1th so that the process in this control cycle is terminated and “RETURN” returns the execution to S14.

When the decision of S52 is affirmative, with the indicator value E (T1=0) as a reference at time T1=0 when warning notification has been performed, the indicator value E increases toward degradation of the power storage device 20 while T1 elapses from T1=0 to T1th, and it is determined (S54) whether or not the increment ΔE={E(T1=T1th)−E(T1=0)} exceeded a predetermined threshold increment (ΔE)₀. This is to determine whether or not the possibility of discharge degradation of the power storage device 20 has further increased.

The threshold increment (ΔE)₀ is set to an increment of a degree at which the possibility of discharge degradation of the power storage device 20 further increases. For example, 10% of E(T1=0) can be set as the threshold increment (ΔE)₀. This numerical value is an example for the purpose of illustration and may be another numerical value depending on the forgetting factor A. When the decision of S54 is negative, the risk of discharge degradation of the power storage device 20 is low so that the process for that control cycle is terminated at “END” and returns to S12. When the decision of S54 is affirmative, the process for stopping the discharging of the power storage device 20 is performed (S34). This procedure is executed by function of the discharge stop processor 48 of the charging/discharging control device 40.

As a process for stopping the discharging of the power storage device 20, the system main relay 22 can be disconnected. At this time, the character display of “RD” on the display section 50 of the display means 13 turns off. Other than these processes, a process capable of stopping the discharging of the power storage device 20 may be performed, and depending on the driving conditions of the hybrid vehicle, a process such as for stopping the operation of all devices of the discharge load 24 may be performed. The buzzer 56 of the notification means 14 remains on, however, the display of the display 54 is changed to a message such as “please promptly change the shift position from the neutral position to another shift position”.

With the discharge stop process being performed, the state variable M3 is changed from “0” to “1”. The state variable M3=1 indicates the history of the discharge stop process being performed. When the state variable becomes M3=1, the history state branching process of FIG. 4 moves to the branch for “discharge stop history exists” (S26). The process in the branch for S26 utilizes an elapsed time T3 after the discharge stop process has been performed so that with the state variable M3 being changed from “0” to “1”, the elapsed time is set to T3=0 and the timer T3 starts counting. Furthermore, the process in the branch of S26 utilizes a counter C2 for counting the number of times the user returns the shift position to then N position so that with the state variable M3 being changed from “0” to “1”, the count value of the counter C2 is reset to 0. When these setting operations (S56) end, the process in that control cycle completes and “RETURN” returns the execution to S14.

By performing the process of S34, for example, even in a case in which the user leaves the shift position at the N position despite the warning of S30 being issued, the discharge degradation of the power storage device 20 can be suppressed.

In the branch for “warning notification cancellation history exists” (S24) in the history state branching process (S16), a process for reinforcing the effect of the warning notification process (S30) and the warning notification cancellation process (S32) is performed.

For example, even when the shift position has been changed from the N position to another shift position in accordance with the warning of S30, a problem occurs if immediately thereafter the shift position is returned to the N position or alternately changed between the N position and another shift position. Namely, by the user temporarily changing the shift position from the N position to another shift position the warning notification cancellation process (S32) is executed and the predetermined warning notification is cancelled. However, when immediately thereafter the shift position is returned to the N position, the shift position will be at the N position without sufficient charging current being supplied to the power storage device 20. At this time, the warning notification may again be performed. However, if the flowchart described in FIG. 4 is followed, when the warning notification process (S30) is at once executed, the history of M1=1 remains so that the execution does not proceed to “no history” (S20) in the history state branching process (S16). Therefore, the warning notification is not performed again and the degradation originating from discharging is not effectively prevented. Thereupon, in such a case, when the warning notification cancellation is performed, the history of M2=1 remains and the execution proceeds to the branch for “warning notification cancellation history exists” (S24) in the history branching process (S16).

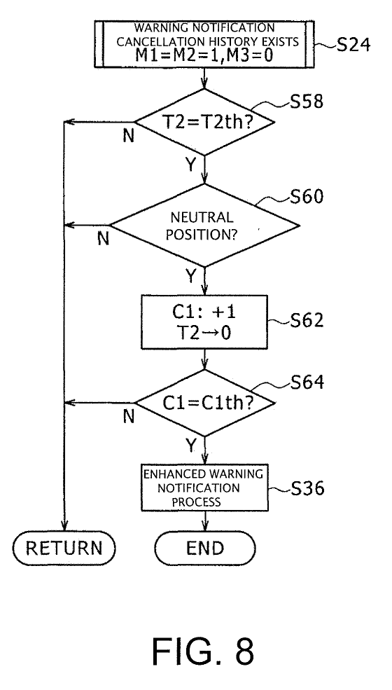

FIG. 8 is a flowchart showing the detailed procedure in the branch for “warning notification cancellation history exists” (S24). This, with the time T2=0 set for M2=1 in the warning notification cancellation process (S32) as reference, determines whether or not the time in which the user returns from another shift position to the N position is too short. T2th is used to indicate too short a time. T2th is set with a short period of a degree at which it is possible to distinguish the case where the shift position has been alternately changed between the N position and another position. For example, it is set to a period several times that of control cycle Δt. As an example T2th=(5˜10)Δt. When set to this short a period, D(−) in the degradation evaluation value D is a small value and degradation originating from discharging is not effectively prevented. The aforementioned numerical value is an example for the purpose of illustration and may be another appropriate numerical value depending on the forgetting factor A.

T2th is set as described hereinabove and it is determined whether or not T2=T2th was achieved (S58). When the decision of S58 is negative, the process in that control cycle completes at “RETURN” and returns to S14. In the next control cycle, the execution proceeds to S24 at the history state branching and the decision of the aforementioned S58 is performed. At that point when T2=T2th has been reached, the decision of S58 is affirmative so that the state of the shift position is acquired and it is determined whether or not the shift position is at the N position (S60). When the decision of S60 is negative, the process in that control cycle completes at “RETURN” and returns to S14.

When the decision of S60 is affirmative, such as in the next control cycle, the state can be considered to be in the next state. Namely, a state in which the user is aware of the warning notification and changes to a shift position other than the N position and as a result the warning notification is cancelled, and thereafter, the user again returns the shift position to the N position during the short time from T2=0 to T2th. In this manner, when the shift position is changed to a shift position other than the N position and in a short time is again returned to the N position, sufficient charging for the power storage device 20 is not performed and an inability to prevent discharge degradation occurs. Thereupon, the counter C1 counts the number of times the N position is returned to in a short time after warning cancellation. Namely, when the branching process of S24 is entered and S58 is affirmative and further S60 is affirmative, the count value of the counter C1 is incremented by +1 and the timer T2 is reset to 0 (S62). Then, it is determined whether or not the count value of the counter C1 has reached a predetermined threshold count C1th (S64). C1th can be set to an integral number of 1 or higher. Since it is possible for the user to return to the N position in a short time by some mistake after the warning has been cancelled, it is preferable to set C1th to 2 or 3. When the decision of C64 is negative, the process in that control cycle completes at “RETURN” and returns to S14.

When S64 is affirmative, such as in the next control cycle, it is determined the user shifted the shift position to the N position at a timing, which is intentionally too fast, and a strong warning is issued with a stronger warning manner than the previous predetermined warning (S36). This procedure is executed by function of the warning notification processor 46 of the charging/discharging control device 40. The content of the warning is identical to the content of the predetermined warning of S30 in FIG. 5 and prompts the user to change the shift position from the N position to another shift position. Notification is performed by the notification means 14.

The stronger warning manner than the previous predetermined warning refers to a manner for conveying the content of the predetermined warning more clearly to the user. In the notification means 14, the volume of the buzzer 56 is set to a volume larger than the previous time and a message is displayed on the display 54, such as “please leave the shift position to a position other than neutral”. The characters on the display 54 may be a larger size. When the notification means 14 includes a warning lamp, the brightness of the warning lamp is made brighter or the blinking rate is increased to blink with frequent intense light. When the notification means 14 includes an audio speaker, the volume is increased and the aforementioned message is output.

When the enhanced warning notification process of S36 is performed, the series of processes until now relating to degradation prevention of the power storage device 20 is terminated at “END” and returns to S12. In this manner, the user is alerted by a strong warning and the initial state is returned to. Instead of this, after confirming the user has, in response to the strong warning notification, maintained the shift position at the N position for a while, the execution may be returned to S12 as “END”. By performing the enhanced warning notification process (S36), even when the shift position was changed from the N position to another shift position in response to the warning of S30, the case of alternately changing between the N position and another shift position can be accommodated and the effect of the warning notification process (S30) and the warning notification cancellation process (S32) can be reinforced while suppressing a decrease in user convenience.

Returning again to FIG. 4, at the branch of “discharge stop history exists” (S26) in the history state branching process (S16), a process is performed to reinforce the effect of the discharge stop process (S34).

For example, when the discharge stop process (S34) is performed to prevent degradation from occurring at the secondary cell, the character display of “RD” on the display section 50 of the display means 13 is turned off. The user can view this, leave the shift position at the N position, and operate the operator 52 to perform the discharge stop cancellation request. In such a case, when the discharge stop is canceled in response to user request, an insufficient supply of charging current to the power storage device 20, which is a secondary cell, occurs and the occurrence of degradation originating from discharging is not effectively prevented. Thereupon, when the discharge stop process (S34) is performed, the history of M3=1 is used and the execution proceeds to the branch of “discharge stop history exists” (S26) in the history state branching process (S16).

FIG. 9 is a flowchart showing the detailed procedure in the branch of “discharge stop history exists” (S26). This, with the time T3=0 set for M3=1 in the discharge stop process (S34) as reference, determines whether or not the time in which the user operates the operator 52 is too short. T3th is used to indicate too short a time. T3th can be set to a similar time as T2th. For example, T3th is set to a period several times the control cycle At. The aforementioned numerical value is an example for the purpose of illustration and may be another appropriate numerical value.

T3th is set as described above and it is determined whether or not T3=T3th has been reached (S66). When the decision of S66 is negative, the process in that control cycle completes at “RETURN” and returns to S14. In the next control cycle, the execution proceeds to S26 from the history state branching and the aforementioned decision of S66 is performed. If T3=T3th has been reached at that point, the decision of S66 is affirmative so that the shift position is acquired and it is determined whether or not the shift position is at the N position (S68). When the decision of S68 is negative, the shift position is not at the N position and the purpose of the discharge stop process (S34) is achieved so that the discharge stop process cancellation is performed (S78). The discharge stop process cancellation returns the system main relay 22 to the connected state. As a result, the character display of “RD” is illuminated on the display 50 of the display means 13. Then, the process in that control cycle completes at “END” and returns to S12.

When the decisions of S66 and S68 are affirmative, such as in the next control cycle, it is determined whether or not the operator 52 has been operated. When the operator 52 is operated, the “RB signal” changes from 0 to 1 and is transferred to the charging/discharging control device 40 so that it is determined whether or not the “RB signal” is 1 (S70). When the decision of S70 is negative, the operator 52 has not been operated, however, the shift position remains at the N position so that the process in that control cycle completes at “RETURN” and returns to S14. When the decision of S70 is affirmative, the state can be considered to be in the next state. Namely, when the discharge stop process (S34) has been performed to prevent degradation of the secondary cell, the character display of “RD” on the display 50 of the display means 13 turns off. This is a state in which the user views this, leaves the shift position at the N position, and operates the operator 52 provided in the vehicle to request discharge stop cancellation.

After the discharge stop process (S34) is performed, within a short time, when a response is made to this user discharge stop cancellation request, sufficient charging for the power storage device 20 is not performed and an inability to prevent discharge degradation occurs. Thereupon, the counter C2 counts the number of times the user operated the operator 52 in a short time after the discharge stop process (S34) was performed with the shift position left at the N position. Namely, when the branching process of S26 is entered and S68 and S70 are affirmative, the count value of the counter C2 is incremented by +1 and the timer T3 is reset to 0 (S72). Then, it is determined whether or not the count value of the counter C2 has reached a predetermined threshold count C2th (S74). C2th can be set to an integral number of 1 or higher. Since it is possible for the user to operate the operator 52 by some mistake, it is preferable to set C2th to 2 or 3. When the decision of S74 is negative, the discharge stop continues, “RD” on the display 50 of the display means 13 remains off (S76), and the process in that control cycle completes at “RETURN” and returns to S14.

When S74 is affirmative, such as in the next control cycle, it is determined the user operated the operator 52 while the shift position was left at the N position and the discharge stop enhanced process (S38) is performed. This procedure is executed by function of the discharge stop processor 48 of the charging/discharging control device 40. For the content of the discharge stop enhanced process (S38), discharge stop cancellation is not performed even if operation of the operator 52 is performed by the user and a predetermined standby time Td is added. The standby time Td is a time for performing the discharge stop cancellation after the time of Td has elapsed from when the operation of the operator 52 was performed. The standby time Td can be set taking into consideration the time required for the user to voluntarily shift the shift position. As an example, Td can be set to a few seconds. Regarding the setting of the standby time Td, a message may be shown on the display 54 of the notification means 14, such as “A discharge stop cancellation request was received but could not be executed. Please promptly change the shift position from the neutral position to another shift position.”

When the discharge stop enhanced process of S38 is performed, a series of processes until this time relating to degradation prevention of the power storage device 20 completes at “END” returns to S12. In this manner, an alert is issued in response to user operation of the operator 52 and the initial state is returned to. Instead of this, after confirming a process is performed in which the user shifts to a shift position other than the N position during the elapse of the standby time Td, the execution may be returned to S12 as “END”. By performing the discharge stop enhanced process (S38), even when the user has performed the discharge stop cancellation request after the discharge stop process (S34), the effect of the discharge stop process (S34) can be reinforced while suppressing a decrease in user convenience.

Regarding the secondary cell having a property in which the ion concentration in electrolytic solution is biased due to discharging, the aforementioned configuration suppresses bias of the ion concentration in electrolytic solution due to discharging, and further can suppress the progress of bias of the ion concentration in electrolytic solution due to discharging so that the occurrence of discharge degradation of the secondary cell can be suppressed.

### REFERENCE SIGNS LIST

10 HYBRID VEHICLE CONTROL SYSTEM
12 SHIFT LEVER MECHANISM
13 DISPLAY MEANS
14 NOTIFICATION MEANS
15, 16 DYNAMO-ELECTRIC MACHINE
17 POWER DISTRIBUTION MECHANISM
18 ENGINE
19 DRIVE CIRCUIT
20 POWER STORAGE DEVICE
22 SYSTEM MAIN RELAY (SMR)
24 DISCHARGE LOAD
26 POWER CONVERTER
28 INVERTER CIRCUIT
29 LOAD
30 INDICATOR VALUE CALCULATOR
40 CHARGING/DISCHARGING CONTROL DEVICE (FOR ONBOARD SECONDARY CELL)
42 INDICATOR VALUE ACQUISITION PROCESSOR
44 SHIFT POSITION ACQUISITION PROCESSOR
46 WARNING NOTIFICATION PROCESSOR
48 DISCHARGE STOP PROCESSOR
50 DISPLAY SECTION
52 (DISCHARGE STOP CANCELLATION REQUEST) OPERATOR
54 DISPLAY
56 BUZZER

1. A charging/discharging control device for onboard secondary cell comprising:
a notification means for notifying a user of a predetermined warning when in a vehicle equipped with an engine, a dynamo-electric machine, and a secondary cell, electric power supply from the engine side to the secondary cell stops, and when an indicator value indicating the degree to which the ion concentration in an electrolytic solution is biased by discharging of the secondary cell exceeds a predetermined cell degradation threshold value.

2. A charging/discharging control device for onboard secondary cell according to claim 1, wherein:
the indicator value is acquired;
a shift position of the vehicle is acquired;
when the acquired shift position is at a neutral position, power supply from the engine side to the secondary cell is stopped, and when the acquired indicator value exceeds the cell degradation threshold value, the notification is performed as the predetermined warning so that the neutral position is changed to another the shift position.

3. A charging/discharging control device for onboard secondary cell according to claim 2, wherein:
after the notification was performed, the acquired indicator value is incremented toward degradation of the secondary cell, and when the increment thereof exceeds a predetermined threshold value increment, a process to stop discharge of the secondary cell is performed.

4. A charging/discharging control device for onboard secondary cell according to claim 2, wherein:
the shift position after the notification is acquired; and
in a predetermined period from the point the notification was performed, after the acquired shift position has been changed from the neutral position to another the shift position, and when again returned to the neutral position, the notification is performed, using a warning manner stronger than the previous predetermined warning of the notification, so that the neutral shift position is changed to another the shift position.

5. A charging/discharging control device for onboard secondary cell according to claim 3, wherein:
after the discharge stop is performed, the shift position is acquired; and
in a predetermined period from the point the notification was performed, when a discharge stop cancellation request is performed by user operation and the acquired shift position remains in a state of the neutral position, a process is performed for adding a predetermined standby time in response to the discharge stop cancellation request by the user.

6. A charging/discharging control device for onboard secondary cell according to claim 1, wherein the indicator value is any one of:
a degradation evaluation value indicating ion concentration bias of electrolytic solution between electrodes of the secondary cell;
an increase rate of cell resistance in a discharging period of the secondary cell; and
a time integration value of discharging current value of the secondary cell.
